(19) United States
(12) Patent Application Publication
(10) Pub. No.: US 2012/0279821 A1
(43) Pub. Date: Nov. 8, 2012

(54) ACTUATING DEVICE FOR A DOUBLE CLUTCH

(75) Inventors: Gerald Kuestler, Staatsangehorigkeit (DE); Dominik Herkommer, Staatsangehorigkeit (DE)

(73) Assignee: Schaeffler Technologies GmbH & Co, KG, Herzogenaurach (DE)

(21) Appl. No.: 13/463,015

(22) Filed: May 3, 2012

(30) Foreign Application Priority Data
May 5, 2011 (DE) DE 102011100625.8

(51) Int. Cl. F16D 28/00; F16D 13/38

(52) U.S. Cl. 192/84.91

(57) ABSTRACT

The invention relates to an actuating device for a double clutch with two friction clutches that are actuatable by means of a respective lever system. The actuating device comprises two actuator units for converting a rotary movement carried out by a respective electric motor about an axis of rotation into a linear movement to actuate a friction clutch. To simplify and improve actuating devices of this general type, a respective planetary rolling contact transmission is arranged coaxially with a rotor of the electric motor and driven by the latter. The planetary rolling contact transmission converts the rotary movement into the linear movement using an exclusively mechanical actuating device. The actuator units are arranged to be parallel with respect to their axes of rotation and are received in a common housing.

This claims the benefit of German Patent Application DE 10 2011 100 625.0, filed May 5, 2011 and hereby incorporated by reference herein.

The invention relates to an actuating device for a clutch including an actuator unit for converting a rotary movement of an electric motor about an axis of rotation into a linear movement for actuating a friction clutch. In particular, the present invention relates to an actuating device for a double clutch including two friction clutches that are actuatable by means of a respective lever system and include two actuator units for converting a rotary movement of a respective electric motor about an axis of rotation into a linear movement for operating a friction clutch.

### BACKGROUND

German Patent Application No. DE 197 009 35 A1 discloses a clutch/transmission actuator that includes an electric motor and a planetary rolling contact transmission. This principle is also implemented in in actuators in accordance with Documents No. DE 10 2010 047 801 A1 and DE 10 2010 047 800 A1. However, a common aspect of these solutions is that they include a hydrostatic section connected between the actuator and the clutch.

### SUMMARY OF THE INVENTION

An actuating device for a double clutch is disclosed in DE 10 2010 025 408 A1, which discloses to operate two actuator units by means of a respective lever whose fulcrum is displaced by a displacement of a bearing block driven by an electric motor via a spindle. The lever that is displaced in this way actuates a lever system of a friction clutch and thus actuates the clutch. The two actuator units are arranged in separate housings and with an angular offset about an axis of rotation of the double clutch.

An actuating device in the form of what is known as a hydrostatic actuator for operating a friction clutch is described in the non-pre-published German Patent Application. The lever system is hydrostatically actuated using a slave cylinder to which pressure is applicable by an electrically actuated master cylinder. An electric motor drives a planetary rolling contact transmission, which in turn operates the piston of the master cylinder by generating hydrostatic pressure. To actuate a double clutch, two of these hydrostatic actuators may be required, which take up a corresponding amount of installation space. Due to the properties of the master/slave cylinder system of the hydrostatic actuator, precautions need to be taken in view of leakages and temperature fluctuations because for lower temperatures increased actuating forces are to be expected.

A lever system that is acted upon by the mechanical release system of the actuator units for operating the friction clutches of the double clutch is known, for example, from WO 03/081039 A1 and from EP 1 508 715 A2.

An object of the invention is to provide an advantageous further development of an actuating device for a double clutch especially with regard to an improved temperature sensibility, a reduced installation space, and a simplified design.

The present invention provides an actuating device for a double clutch including two friction clutches that are actuatable by a respective lever system and include two actuator units for converting a rotary movement carried out by a respective electric motor about an axis of rotation into a linear movement for actuating a friction clutch. A respective planetary rolling contact transmission is arranged coaxially with a rotor of the electric motor and is driven by the latter. The planetary rolling contact transmission converts the rotary movement into the linear movement using a mechanical actuator system that is of exclusively mechanic design. The actuator units are arranged to have parallel axes of rotation and are received in a common housing. Since the actuator system is purely mechanical, it is substantially temperature-independent and can thus be actuated by virtually the same forces over the entire temperature range. Even for very low temperatures, no additional motor capacity of the electric motors needs to be provided.

As explained above, a clutch/transmission actuator that includes an electric motor and a planetary rolling contact transmission with a hydrostatic section connected between the actuator and the clutch is known in the art. Among other aspects, the present invention proposes to replace this hydrostatic section with pull ropes (or alternatively with push rods) in connection with actuating levers—which are basically known in the art—especially for double clutch applications.

Since the effective direction of the mechanical actuator system is parallel to the axis of rotation of the double clutch, this is in the direction of the linear movement of the actuation of the double clutch, the mechanical actuator system can be of simple construction. For instance, depending on the design of the lever system of the friction clutches, if the friction clutch is pulled closed or open, a pull rope arranged between the spindle of the planetary rolling contact transmission and the lever system may act as the mechanical actuator system. If a friction clutch that is pushed open or closed is provided, push rods may be provided in a corresponding way between the spindle and the lever system. If one or both of the friction clutches of the double clutch are embodied as normally closed clutches, they are pulled open by a pull rope or pushed open by a push rod. Alternatively, one or both of the friction clutches may be normally open clutches, i.e. they may be pulled closed by a wire rope or pushed closed by a push rod.

In accordance with the idea of the invention, each of the planetary rolling contact transmissions is arranged radially inside the rotor of an electric motor. Thus the actuator units and consequently the entire actuating device may be relatively short in the axial direction. The assemblies consisting of the rotor and the planetary rolling contact transmission are arranged on the housing to be rotatable and axially fixed. For this purpose, two respective rolling contact bearings may be provided. These bearings may be grooved ball bearings and are spaced apart in the axial direction and received on the housing. The respective stators of the electric motors may be fixed to the housing between these rolling contact bearings.

For cost-efficiency reasons and to reduce the required installation space even further, both actuator units are controlled by a common circuit board, which is received in the housing, and are supplied with electrical power by a power electronic device received on the circuit board. The circuit board is preferably connected to a superordinate control and power supply device using a single plug that has separate control and supply lines for each actuator unit to ensure that when the electronic system of one actuator unit fails or a line fault occurs in one actuator unit, the other actuator unit can continue to be operated without any negative effect.

In accordance with the invention, the spindle of each individual actuator unit is fixed against rotation relative to the housing to ensure that it carries out an exclusively axial linear movement to actuate the friction clutch. For this purpose, the spindle is received in an anti-rotation device that passes axially through the housing.

BRIEF DESCRIPTION OF THE DRAWINGS

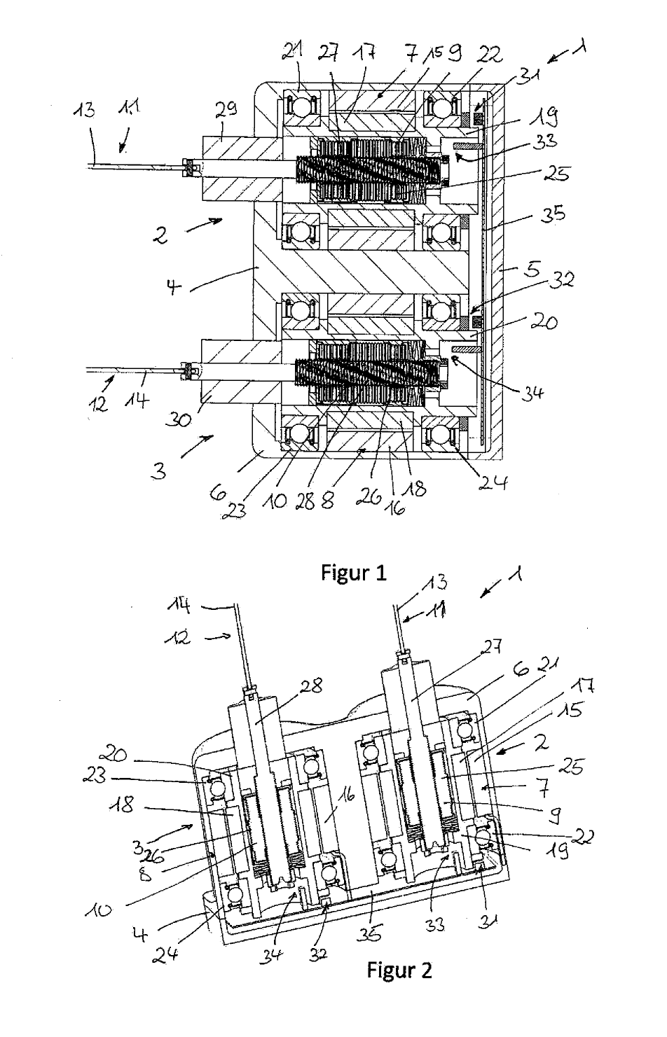

The invention will be explained in more detail below based on the exemplary embodiment illustrated in FIGS. 1 to 3, wherein

FIG. 1 is a sectional view of an actuating device including an actuator unit integrated into a housing,

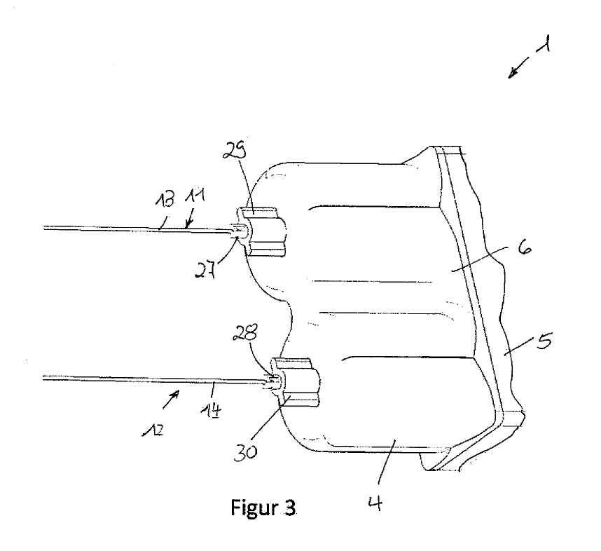

FIG. 2 is a three-dimensional sectional view of the actuating device shown in FIG. 1,

and

FIG. 3 is a three-dimensional view of the actuating device shown in FIG. 1.

### DETAILED DESCRIPTION OF AN EMBODIMENT

FIGS. 1 to 3 together illustrate the actuating device 1 for actuating two friction clutches of a double clutch. For this purpose, the two actuator units 2,3, each of which acts on one friction clutch, are received in a common housing 4 consisting of a base plate 5 and a housing part 6, which is subdivided, for example along the cutting line of FIGS. 1 and 2. Suitable non-illustrated fasteners adapted to the fastening conditions are used to mount the housing 4 to a component of a drive train that includes the double clutch, for instance to the cover of a double clutch transmission.

Each of the actuator units 2, 3 comprises an electric motor 7, 8, a planetary rolling contact transmission 9, 10 driven by the respective electric motor 7, 8, and the mechanical actuator system 11, 12. In the illustrated embodiment, the mechanical actuator system 11, 12 is embodied as a pull rope or push or pull rod 13, 14 for applying traction to a respective non-illustrated lever system of the friction clutches to be actuated. The stator 15, 16 of each electric motor 7, 8 is fixedly connected to housing part 6. The rotor 17, 18 is received in guide element 19, 20 to be fixed against rotation relative thereto. By means of rolling contact bearings 21, 22, 23, 24, guide element 19, 20 is received on the housing so as to be axially supported and rotatable. The guide elements 19, 20 drive the planetary rolling contact bodies 25, 26, which are distributed along the circumference and in turn drive spindles 27, 28. The spindles 27, 28 are arranged in housing part 6 in a way to be fixed against rotation by means of anti-rotation devices 29, 30. Thus the rotary driving action generated by the respective rotor 17, 18 is converted into a linear movement of the spindles 27, 28 due to the action of planetary rolling contact bodies 25, 26. Pull ropes or push or pull rods 13, 14 are secured in the spindles 27, 28.

The movements of the actuator units 2, 3 are detected independently of each other using different sensor devices 31, 32, 33, 34. Sensor devices 31, 32 detect the angle of rotation of the rotors 17, 18 and of the guide elements 19, 20, respectively, whereas sensor devices 33, 34 detect the absolute path of the spindles 27, 28 relative to the housing 4.

A single circuit board 35, which supplies power to and controls both actuator units 2, 3, is received on the base plate 5. The circuit board 35 accommodates a corresponding electronic control system, a power electronic device, and the components of the sensor devices 31, 32, 33, 34 that are fixed to the frame. Both actuator units 2, 3 are operatable independently of each other to ensure that when components of the circuit board 35 for one actuator unit 2, 3 fail, the other actuator unit 2, 3 can continue to operate without any negative effects. The circuit board 35 is thermally coupled to the base plate 5, which is made of a thermally conductive material. Thus heat generated by the power electronic device in particular is transferred to the base plate 5, which transfers it to the fasteners and from them to the housing that receives the actuating device 1. Preferably a single plug connection is used to connect the circuit board 35 to a power supply for operating the power electronic device of the electric motors 7, 8 and to a signal line for transmitting signals to and from a control device such as a clutch or transmission control unit. The signal line may be a CAN bus for controlling the actuator units 2, 3.

### LIST OF REFERENCE SYMBOLS

1 actuating device
2 actuator unit
3 actuator unit
4 housing
5 base plate
6 housing part
7 electric motor
8 electric motor
9 planetary rolling-contact transmission
10 planetary rolling-contact transmission
11 mechanical actuator system
12 mechanical actuator system
13 pull rope, push rod, or pull rod
14 pull rope, push rod, or pull rod
15 stator
16 stator
17 rotor
18 rotor
19 guide element
20 guide element
21 rolling contact bearing
22 rolling contact bearing
23 rolling contact bearing
24 rolling contact bearing
25 planetary rolling contact body
26 planetary rolling contact body
27 spindle
28 spindle
29 anti-rotation device
30 anti-rotation device
31 sensor device
32 sensor device
33 sensor device
34 sensor device
35 circuit board

We claim

1. An actuating device for a double clutch with two friction clutches actuatable by a respective lever system, comprising:
two actuator units for converting a rotary movement carried out by a respective electric motor about an axis of rotation into a linear movement for actuating a respective one of the friction clutches, wherein a respective planetary rolling contact transmission is arranged coaxially with a rotor of the electric motor and is driven by the electric motor, the planetary rolling contact transmission converting the rotary movement into the linear movement using a mechanical actuator system of exclusively mechanical construction, the actuator units being arranged in a common housing so as to be parallel with respect to their axes of rotation.

2. The actuating device as recited in claim 1 wherein stators of the electric motors are fixedly received and positioned in the housing and wherein each of the planetary rolling contact transmissions radially surrounded by the rotors is supported on the housing on both sides at an axial distance to the rotors by rolling contact bearings.

3. The actuating device as recited in claim 1 wherein the axes of rotation of the electric motors are parallel to an axis of rotation of the double clutch.

4. The actuating device as recited in claim 1 wherein at least one mechanical actuator system is a pull rope for applying traction to a lever system of the friction clutches.

5. The actuating device as recited in claim 1 wherein at least one mechanical actuator system is a push rod for applying pressure to a lever system.

6. The actuating device as recited in claim 1 wherein for control and power supply purposes both actuator units have a common circuit board received in the housing.

7. The actuating device as recited in claim 6 wherein the circuit board is in operative connection with a superordinate control and power supply device by a single plug connection having separate control and supply lines for each actuator unit.

8. The actuating device as recited in claim 1 wherein each of the planetary rolling contact transmissions is secured against rotation relative to the housing by a respective anti-rotation device axially passing through the housing and receiving a spindle of the planetary rolling contact transmission.

9. An actuating device for a clutch comprising:
an actuator unit for converting a rotary movement carried out by a respective electric motor about an axis of rotation into a linear movement for actuating the friction clutch, wherein a transmission is arranged coaxially with a rotor of the electric motor and is driven by the electric motor, the transmission converting the rotary movement into the linear movement using a mechanical actuator system of exclusively mechanical construction, an output side of the transmission connectable to the clutch using a pull rope connection or a pull rod or a push rod.

10. The actuating device as recited in claim 9 wherein the pull rope connection or pull rod or push rod is in connection with a lever transmission.

11. The actuating device as recited in claim 9 wherein the transmission is a planetary rolling contact transmission.
